(19) United States
(12) Patent Application Publication
(10) Pub. No.: US 2010/0128992 A1
(43) Pub. Date: May 27, 2010

(54) Method and Dual Laser Device for Detecting Magnifying Optical Systems

(75) Inventors: Jean-Louis Duvent, Nozay (FR); Jean-Yves Thomas, Nozay (FR); Pierre Morin, Villebon Sur Yvette (FR)

Correspondence Address: Dickinson Wright PLLC;James E. Ledbetter, Esq., International Square, 1875 Eye Street, N.W., Suite 1200, Washington, DC, 20006, US

(73) Assignee: COMPAGNIE INDUSTRIESLLE DES LASERS CILAS, ORLEANS (FR)

(21) Appl. No.: 12/595,218

(22) PCT Filed: Apr. 7, 2008
(86) PCT No.: PCT/FR08/00485

§ 371 Date: Oct. 8, 2009

(51) Int. Cl. G06K 9/68; H01J 3/14

(52) U.S. Cl. 382/218; 250/578.1

(57) ABSTRACT

The invention comprises illuminating a scene where said magnifying optical system (OP) may occur with at least a first and a second pulses respectively generated by first and second laser transmitters (E1, E2). The first laser transmitter (E1) and a detector of the scene thus illuminated (D) are adjacent, while the second laser transmitter (E2) is remote from said detector (D) transversally to the direction (d) of said scene.

The present invention relates to a method and a device for detecting magnifying optical systems.

It is known that magnifying optical systems (such as sighting scopes and eyes) exhibit the property that they retroreflect light. So, to detect such a magnifying optical system situated in a scene, it is known to illuminate said scene by laser pulses and to capture images thereof in synchronism with the corresponding laser illuminations. Thus, a luminous spot corresponding to said magnifying optical system appears on said images.

However, other retroreflecting objects, such as motor vehicle reflectors, signposts, etc, may be situated in said scene thus illuminated. It follows from this that the luminous spots shown by the images do not necessarily correspond to magnifying optical systems and that an ambiguity therefore exists as regards the detection of the latter.

The object of the present invention is to remedy this drawback.

To this end, according to the invention, the method for distinguishing at least one magnifying optical system from among other objects, capable of retroreflecting light, situated in a scene, according to which method:
said scene is illuminated by at least one first laser pulse emitted by a first laser emitter, and a first image of said scene illuminated by said first pulse is captured by means of a detector observing said scene, said detector and said first laser emitter being at least approximately adjacent transversely to the direction of said scene;
said scene is illuminated by at least one second laser pulse emitted by a second laser emitter offset from said detector transversely to the direction of said scene, said detector being sensitive to said second pulse; and
at least one second image of said scene illuminated by said second pulse is captured by means of said detector,
   is noteworthy in that, after comparison of said first and second images, it is considered:
that said objects, whose images are situated in said first and second images of said scene, are not magnifying optical systems; and
that said objects, whose images are situated in the first image of said scene, but are absent from said second image of the latter, are magnifying optical systems.

Specifically, the Applicant has observed that the retroreflection cone of a magnifying optical system is very narrow (of the order of 0.1 mrad), whereas that of standard reflectors is much wider (equal to 50 mrads at least). Thus, by offsetting said second emitter from the detector, the latter will be able to receive the light emitted by the second emitter and retroreflected by the standard reflectors, but will not see this light retroreflected by a magnifying optical system.

Of course, the transverse offset between the second laser emitter and said detector making it possible to benefit from the invention depends on the distance separating the detector and said magnifying optical system, as well as on the angle of the latter's cone of retroreflection. Nevertheless, experience has shown that a fixed transverse offset at least equal to 200 mm, preferably of the order of 400 mm, made it possible to distinguish an optical system from a standard reflector for distances of between a few meters and several kilometers.

Said first and second pulses can exhibit the same emission wavelength; they are then temporally staggered. In this case, the temporal stagger between said first and second laser pulses is chosen to be sufficiently small for the scene to be at least approximately identical in said first and second images. It is advantageous to illuminate said scene by means of a series of first and second laser pulses intertwined in such a way that a first (or a second) pulse is inserted between two second (or two first) pulses, to carry out the capturing of first and of second successive and intertwined images in correspondence with said first series and to compare each time a first and a second image that are temporally close to one another.

As a variant, said first and second laser pulses are simultaneous and exhibit different emission wavelengths and said detector (comprising for example two CCD matrices or two parts of a CCD matrix dedicated respectively to said first and second laser pulses) is chosen so as to deliver two different images corresponding respectively to these two wavelengths. Preferably, these wavelengths are sufficiently close to one another for the backscattering of the sunlight by said scene to be at least approximately similar in said first and second simultaneous images. It is then advantageous to illuminate said scene by means of a series of pairs of laser pulses each comprising a first and a second simultaneous laser pulse, to carry out the capturing of successive pairs of images corresponding to said pairs of laser pulses and to successively compare the first image and the second image of each pair of images.

The present invention relates moreover to a device for detecting a magnifying optical system situated in a scene with other objects capable of retroreflecting light, said device comprising a first laser emitter for illuminating said scene and a detector capable of detecting the light retroreflected by said objects illuminated by said first emitter, said detector and said first laser emitter being at least approximately adjacent transversely to the direction of said scene, and a second laser emitter offset from said detector transversely to the direction of said scene, said detector being sensitive to the emission wavelength of said second emitter.

The figures of the appended drawing will elucidate the manner in which the invention may be embodied. In these figures, identical references denote similar elements.

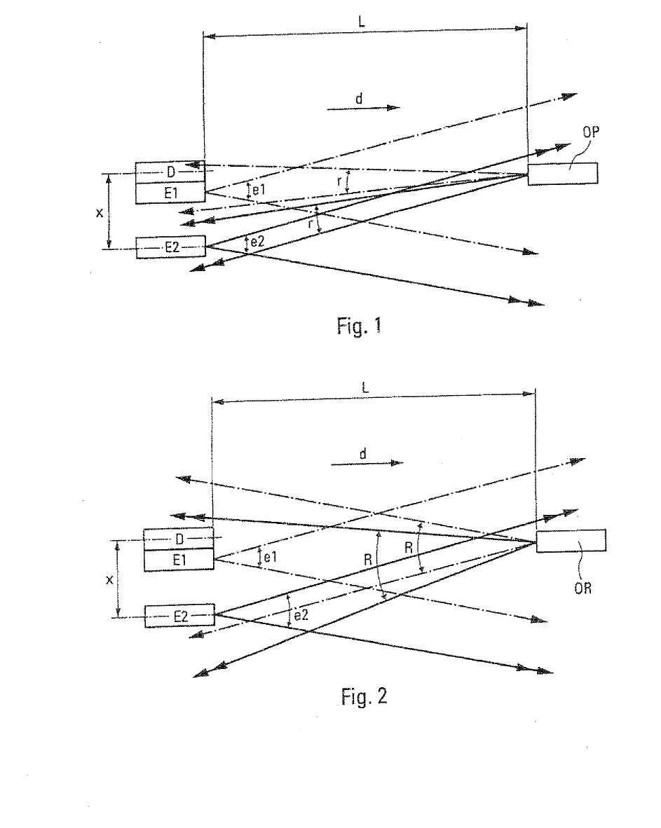

FIG. 1 schematically illustrates the present invention in the case of a magnifying optical system.

FIG. 2 schematically illustrates the present invention in the case of a standard reflector.

Represented in these figures is a device in accordance with the present invention comprising a first and a second pulse laser emitter E1 and E2 and a detector D, for example of the CCD matrix(matrices) type.

The first laser emitter E1 and the detector D are very close to one another and can even form a single physical unit. They are oriented in a direction d, towards a scene which is the distance L away and in which an object OP or OR capable of retroreflecting light is situated.

On the other hand, the second laser emitter E2 is separated, transversely to the direction d, from the detector D by an offset x.

In FIGS. 1 and 2, the angles of the emission cones of the laser emitters E1 and E2 have been denoted by e1 and e2, respectively.

The retroreflecting object OP, shown in FIG. 1, is a magnifying optical system, such as an eye, a sighting scope, etc. Accordingly, its retroreflection cone is narrow, with an angle r, for example of the order of 0.1 mrad. As a result, as represented in FIG. 1, the light emitted by the emitter E1 adjacent to the detector D and retroreflected by the magnifying optical system OP in a narrow retroreflection cone such as this, may be received by said detector D. On the other hand, the light emitted by the second emitter E2, offset from the detector D, and retroreflected by the magnifying optical system OP in a similar narrow retroreflection cone, may not be received by said detector D.

Thus, when the retroreflecting object is a magnifying optical system OP, the detector D may only receive the light emitted by the first emitter E1, adjacent, and retroreflected by the magnifying optical system OP.

When, as is represented in FIG. 2, the retroreflecting object is a standard reflector OR, the latter's cone of retroreflection is wide, with an angle R, for example at least equal to 50 mrad. As a result, the light emitted by the first emitter E1 adjacent to the detector D, as well as that emitted by the second emitter E2 offset from said detector D, are received by the latter.

The laser emission of the first emitter E1 can consist of a train of first pulses. Likewise, the laser emission of the second emitter E2 can consist of a train of second pulses. For its part, the detector D is able, in synchronism with said first and second pulses respectively, to form first and second images of the scene in which the retroreflecting objects OP and OR are situated.

From the above, it is therefore deduced that:

in the case where the retroreflecting object is a standard reflector OR, said first images and also said second images formed by the detector D comprise the image of the object OR illuminated by said first and second laser pulses, respectively; and

in the case where the retroreflecting object is a magnifying optical system OP, only said first images comprise the image of the object OP illuminated by said first laser pulses, said second images not being able to comprise the image of the object OP illuminated by said second laser pulses.

Said first and second laser pulses can have the same emission wavelength. In this case, they are temporally staggered and said first and second pulses can form a series in which they are intertwined, a first laser pulse being inserted between two second pulses and vice-versa.

Conversely, said first and second laser pulses can be simultaneous, but they then exhibit different emission wavelengths to which said detector D is also sensitive.

Whatever the mode of emission of said first and second laser pulses, it results from the above that the comparison carried out by the detector D, of a first and of a second image corresponding respectively to a first and to a second laser pulse, which are simultaneous or temporally close to one another, makes it possible to consider that:
if the first image and the second image both comprise the image of the retroreflecting object, the latter is a standard reflector; and
if only the first image comprises the image of the retroreflecting object, the latter is a magnifying optical system.

Experience has shown that the above was satisfied when the transverse offset x between the second emitter E2 and the detector D was at least equal to 200 mm and, preferably, of the order of 400 mm.

1-11. (canceled)

12. A method for distinguishing at least one magnifying optical system (OP) from among other objects (OR), capable of retroreflecting light, situated in a scene, according to which method:
illuminating said scene by at least one first laser pulse emitted by a first laser emitter (E1) and a first image of said scene illuminated by said first pulse is captured by means of a detector (D) observing said scene, said detector (D) and said first laser emitter (E1) being at least approximately adjacent transversely to the direction (d) of said scene;
illuminating said scene by at least one second laser pulse emitted by a second laser emitter (E2) offset from said detector (D) transversely to the direction (d) of said scene, said detector (D) being sensitive to said second pulse; and
capturing at least one second image of said scene illuminated by said second pulse by said detector (D),
wherein, after comparison of said first and second images, it is considered:
that said objects (OR), whose images are situated in said first and second images of said scene, are not magnifying optical systems (OP); and
that said objects (OP), whose images are situated in the first image of said scene, but are absent from said second image of the latter, are magnifying optical systems (OP).

13. The method as claimed in claim 12, wherein the transverse offset (x) between said second laser emitter (E2) and said detector (D) is at least equal to 200 mm.

14. The method as claimed in claim 13, wherein said transverse offset (x) is of the order of 400 mm.

15. The method as claimed in claim 12, wherein said first and second laser pulses are simultaneous and exhibit different emission wavelengths and said detector (D) is configured so as to deliver two different images corresponding respectively to these two wavelengths.

16. The method as claimed in claim 15, wherein said wavelengths are sufficiently close to one another for the backscattering of the sunlight by said scene to be at least approximately similar in said first and second simultaneous images.

17. The method as claimed in claim 15, wherein said scene is illuminated by means of a series of pairs of laser pulses each comprising a first and a second simultaneous laser pulse, the capturing of successive pairs of images corresponding to said pairs of laser pulses is carried out and the first image and the second image of each pair of images are compared successively.

18. The method as claimed in claim 12, wherein said first and second laser pulses have the same wavelength and are temporally staggered.

19. The method as claimed in claim 18, wherein the temporal stagger between said first and second laser pulses is sufficiently small for the scene to be at least approximately identical in said first and second images.

20. The method as claimed in claim 18, wherein said scene is illuminated by employing a series of first and second laser pulses intertwined in such a way that a first (or a second) pulse is inserted between two second (or two first) pulses, the capturing of the first and of second successive and intertwined images is carried out in correspondence with said first series and each time a first and a second image that are temporally close to one another are compared.

21. A device for detecting a magnifying optical system (OP) situated in a scene with other objects (OR) capable of retroreflecting light, said device comprising:
a first laser emitter (E1) for illuminating said scene and a detector (D) configured to detect the light retroreflected by said objects illuminated by said first emitter (E1), said detector (D) and said first laser emitter (E1) being at least approximately adjacent transversely to the direction (d) of said scene; and
a second laser emitter (E2) offset from said detector (D) transversely to the direction (d) of said scene, said detector (D) being sensitive to the emission wavelength of said second emitter,
wherein the transverse offset (x) between said second laser emitter and said detector is at least equal to 200 mm.

22. The device as claimed in claim 21, wherein said transverse offset (x) is of the order of 400 mm.
